(19) United States
(12) Patent Application Publication
(10) Pub. No.: US 2023/0016298 A1
(43) Pub. Date: Jan. 19, 2023

(54) METHOD AND APPARATUS FOR COOLING IN LIQUEFACTION PROCESS

(71) Applicant: Highview Enterprises Limited, London (GB)

(72) Inventors: Robert Morgan, Shoreham-by-Sea (GB); Stuart Nelmes, Reigate (GB); Nicola Castellucci, Woking (GB); Daniel Harris, Feltham (GB)

(21) Appl. No.: 17/854,466

(22) Filed: Jun. 30, 2022

Related U.S. Application Data
(62) Division of application No. 14/411,533, filed on Dec. 29, 2014, now abandoned.

(30) Foreign Application Priority Data
Jul. 6, 2012 (GB) 1212056.4
Mar. 27, 2013 (GB) 1305641.1

(51) Int. Cl. F25J 1/00; F25J 1/02

(52) U.S. Cl. CPC F25J 1/00; F25J 1/004; F25J 1/0012; F25J 1/0015; F25J 1/0035; F25J 1/0037; F25J 1/0045; F25J 1/0052; F25J 1/0082; F25J 1/0202; F25J 1/0208; F25J 1/0228; F25J 1/0242; F25J 1/0251; F25J 1/0292; F25J 2205/24; F25J 2230/06; F25J 2270/06

(57) ABSTRACT

Methods and apparatus are disclosed for efficient cooling within air liquefaction processes with integrated use of cold recycle from a thermal energy store.

### CROSS-REFERENCE TO RELATED APPLICATIONS

The present application is a division of U.S. Pat. Application Serial No. 14/411,533, filed Dec. 29, 2014, which is a national stage of PCT/GB2013/051797, filed Jul. 8, 2013, which claims the priority benefit of United Kingdom Pat. Application Serial No. 1305641.1, filed Mar. 27, 2013, and United Kingdom Pat. Application Serial No. 1212056.4, filed Jul. 6, 2012, all of which are incorporated by reference herein in their entireties.

### FIELD OF THE INVENTION

The present invention relates to cryogenic energy storage systems, and particularly to methods for the efficient balancing of the liquefaction process with the integrated use of cold recycle from an external source such as a thermal energy store.

### BACKGROUND OF THE INVENTION

Electricity transmission and distribution networks (or grids) must balance the generation of electricity with the demand from consumers. This is normally achieved by modulating the generation side (supply side) by turning power stations on and off, and running some at reduced load. As most existing thermal and nuclear power stations are most efficient when run continuously at full load, there is an efficiency penalty in balancing the supply side in this way. The expected introduction of significant intermittent renewable generation capacity, such as wind turbines and solar collectors, to the networks will further complicate the balancing of the grids, by creating uncertainty in the availability of parts of the generation fleet. A means of storing energy during periods of low demand for later use during periods of high demand, or during low output from intermittent generators, would be of major benefit in balancing the grid and providing security of supply.

Power storage devices have three phases of operation: charge, store and discharge. Power storage devices generate power (discharge) on a highly intermittent basis when there is a shortage of generating capacity on the transmission and distribution network. This can be signalled to the storage device operator by a high price for electricity in the local power market or by a request from the organisation responsible for the operating of the network for additional capacity. In some countries, such as the United Kingdom, the network operator enters into contracts for the supply of back-up reserves to the network with operators of power plants with rapid start capability. Such contracts can cover months or even years, but typically the time the power provider will be operating (generating power) is very short. In addition, a storage device can provide an additional service in providing additional loads at times of oversupply of power to the grid from intermittent renewable generators. Wind speeds are often high overnight when demand is low. The network operator must either arrange for additional demand on the network to utilise the excess supply, through low energy price signals or specific contracts with consumers, or constrain the supply of power from other stations or the wind farms. In some cases, especially in markets where wind generators are subsidised, the network operator will have to pay the wind farm operators to ‘turn off’ the wind farm. A storage device offers the network operator a useful additional load that can be used to balance the grid in times of excess supply.

For a storage device to be commercially viable the following factors are important: capital cost per MW (power capacity), MWh (energy capacity), round trip cycle efficiency and lifetime with respect to the number of charge and discharge cycles that can be expected from the initial investment. For widespread utility scale applications it is also important that the storage device is geographically unconstrained - it can be built anywhere, in particular next to a point of high demand or next to a source of intermittency or a bottleneck in the transmission and distribution network.

One such storage device technology is the storage of energy using cryogen such as liquid air or nitrogen (Cryogenic Energy Storage (CES)) which offers a number of advantages in the market place. Broadly speaking a CES system would be connected to an electricity supply grid in order to, in the charge phase, utilise low cost or surplus electricity, at periods of low demand or excess supply from intermittent renewable generators, to liquefy a working fluid such as air or nitrogen. This is then stored as a cryogenic fluid in a storage tank, and subsequently released to drive a turbine, producing electricity during the discharge or power recovery phase, at periods of high demand or insufficient supply from intermittent renewable generators.

Cryogenic Energy Storage (CES) Systems have several advantages over other technologies in the market place, one of which is their founding on proven mature processes. Means to liquefy air, necessary in the charging phase, have existed for more than a century; early systems utilised a simple Linde cycle in which ambient air is compressed to a pressure above critical (≥ 38 bar), and progressively cooled to a low temperature before experiencing an isenthalpic expansion through an expansion device such as a JouleThomson valve to produce liquid. By pressurising the air above the critical threshold, the air develops unique characteristics and the potential for producing large amounts of liquid during expansion. The liquid is drained off and the remaining fraction of cold gaseous air is used to cool the incoming warm process stream. The amount of liquid produced is governed by the required amount of cold vapour and inevitably results in a low specific yield.

An evolution of this process is the Claude cycle (for which the current state of the art is shown in FIG. 4); the process is broadly the same as the Linde cycle however one or more streams 36, 39 are separated from the main process stream 31 where they are expanded adiabatically through turbines 3, 4, resulting in a lower temperature for a given expansion ratio than an isenthalpic process and hence efficient cooling. The air expanded through turbines 3, 4 then rejoins the returning stream 34 and aids the cooling of the high pressure stream 31 via heat exchanger 100. Similar to the Linde cycle the bulk of liquid is formed via expansion through an expansion device such as a Joule-Thomson valve 1. The main improvement with the Claude process is that power produced by the expansion turbines 3, 4 directly or indirectly reduces the overall power consumption, resulting in greater energy efficiency.

The most efficient modern air liquefaction processes typically use a two turbine Claude design, and at commercial scale can typically achieve an optimum specific work figure of around 0.4 kWh/kg. Although highly efficient this would not enable a CES system to achieve a market entry Round Trip Efficiency figure of 50%, without significant reductions in specific work.

In order to achieve greater efficiencies the liquefaction process within a fully integrated CES system, such as the one disclosed in WO2007-096656A1, utilises cold energy captured in the evaporation of the cryogen during the power recovery phase. This is stored by means of an integrated thermal store, such as the one detailed in GB 1115336.8, and then used during the charging phase to provide additional cooling to the main process stream in the liquefaction process. The effective use of the cold recovery stream is a prerequisite to achieving an efficient cryogenic energy storage system.

The necessary change in enthalpy that an arbitrary high pressure process stream must undergo to reach the required temperature to maximise liquid production when expanded through an expansion device such as a Joule-Thomson valve is shown in FIG. 1. A typical ideal cooling stream must similarly undergo an enthalpy change throughout the process as shown by the profile in FIG. 2, marked ‘No Cold Recycle’. The second profile in FIG. 2 demonstrates the dramatic change in required cooling (i.e. relative change of enthalpy) when large quantities of cold recycle are introduced into the system, marked ‘Cold Recycle’. FIG. 2 shows quantities of cold recycle in the region of 250 kJ/kg (defined as cooling enthalpy per kg of liquid product delivered), which is consistent with levels of cold recycle used in a fully integrated cryogenic energy system such as the one disclosed in WO2007-096656A1. As is evident from FIG. 2, the addition of the cold recycle completely satisfies the cooling requirements in the higher temperature end of the process.

This presents a problem with current state of the art liquefaction processes which are designed to be used with more progressive thermal energy profiles, and are much more effectively handled by a single cooling stream running the extent of the heat exchanger. As can be seen from FIG. 3 the effective cooling stream produced by current state of the art processes (indicated by profile marked ‘state of the art’), such as the Claude cycle shown in FIG. 4, provides a cumulative relative change in total enthalpy that is extremely linear relative to the cooled stream temperature in comparison to the required profile in a system using large quantities of cold recycle (indicated by profile marked ‘Ideal Profile’), and a very poor match to the ideal profile which has a non-progressive and non-linear relationship between cumulative relative change in total enthalpy and the cooled stream temperature. To meet the acute cooling demand at the lower temperature end shown by the flat section of the “Ideal Profile” graph in FIG. 3, a typical state of the art process must expand a similar quantity of air through the cold turbine as a system without cold recycle. This results in poor efficiencies and heat transfer requirements above the maximum design level of the device within the process heat exchangers.

The present inventors have identified that there is a need for a system that can provide focused non-progressive, non-linear cooling to targeted concentrated areas of the process, in particular at the lower temperature end of the process, in order to achieve a cumulative relative change in total enthalpy relative to the cooled stream temperature that is closer to the “ideal profile” of FIG. 3.

### SUMMARY OF THE INVENTION

A first aspect of the present invention addresses these needs by providing, in a first embodiment, a cryogenic liquefaction device comprising:
a heat exchanger; a first phase separator; a first expansion device; a first expansion turbine; a second expansion turbine; a cold recovery circuit including a heat transfer fluid; and an arrangement of conduits, wherein: the operating inlet pressures of the first and second expansion turbines are different from one another; and the arrangement of conduits is arranged such that:
   a first portion of a pressurised stream of gas is directed through the heat exchanger, the first expansion device and the first phase separator; a second portion of the pressurised stream of gas is directed through the first expansion turbine, then through the heat exchanger in a counterflow direction to the first portion of the pressurised stream of gas, and then through the second expansion turbine, and the heat transfer fluid is directed through the heat exchanger.

In the context of the present invention, the phrase “a counter-flow direction” is used to mean that the second portion of the pressurised stream of gas flows through the heat exchanger in an opposite direction to the first portion of the pressurised stream of gas, for at least a part of its path through the heat exchanger. The first and second portions of the pressurised stream of gas may enter the heat exchanger at opposite ends, i.e. so that the temperature difference between the entry points is maximised. Alternatively, the first and or second portion of the pressurised stream of gas may enter the heat exchanger at a point between the ends of the heat exchanger, but flow through the heat exchanger in an opposite direction to the other of the first and second portion of the pressurised stream of gas, for at least a part of its path through the heat exchanger.

The cold recovery circuit comprises a thermal energy storage device for storing cold thermal energy, a means for circulating the heat transfer fluid (HTF), and an arrangement of conduits arranged to direct the HTF through the thermal energy storage device and into the heat exchanger. An exemplary cold recovery circuit is described in detail in GB 1115336.8. The HTF may comprise a gas or a liquid, at high or low pressure.

The configuration of the present invention is such that the second portion of the cooled process stream can be partially expanded through the first turbine to provide a high pressure cooling stream local to the entry point of the cold recovery stream of the cold recovery circuit. The stream can then be further expanded through the second turbine to provide significant additional cooling to the lower section of the process.

The present invention offers increased work output from the expansion turbines as a result of the reheating of the expanded stream, whilst also providing cooling between expansion turbines.

The pressurised stream of gas may consist of gaseous air. Alternatively, the pressurised stream of gas may consist of gaseous nitrogen. The pressurised stream of gas may be input into the cryogenic liquefaction device at a pressure greater than or equal to the critical pressure which, for gaseous air is 38 bar and for gaseous nitrogen is 34 bar.

After the pressurised stream of gas is split into two portions, the first portion of the pressurised stream of gas and the second portion of the pressurised stream of gas may be at the same pressure. Alternatively, the first portion of the pressurised stream of gas and the second portion of the pressurised stream of gas may be at different pressures. In particular, the first portion may be above the critical pressure, and the second portion may be below the critical pressure, or vice versa.

The cryogenic liquefaction device may comprise more than two expansion turbines, with turbines in both parallel and series.

The cryogenic liquefaction device may further comprise a third expansion turbine, wherein the operating inlet pressure of the third expansion turbine is different to at least one of the first and second expansion turbines.

The arrangement of conduits may be such that the third expansion turbine is in parallel with at least one of the first and second turbines such that at least a portion of the second portion of the pressurised stream of process gas is directed through the third turbine.

The arrangement of conduits may be such that the third expansion turbine is in series with at least one of the first and second turbines such that at least a portion of the second portion of the pressurised stream of process gas is directed through the third turbine.

The cryogenic liquefaction device may further comprise a refrigerant circuit which is connected to the output of the second expansion turbine via the arrangement of conduits.

The cryogenic liquefaction device may further comprise a second arrangement of conduits that directs a second heat transfer fluid through a closed cycle refrigeration circuit and through a localised area of the heat exchanger. The second heat transfer fluid within the refrigerant circuit may comprise a gas or a liquid, at high or low pressure.

The cryogenic liquefaction device may further comprise a fourth expansion turbine, wherein the arrangement of conduits is arranged such that:

a third portion of the pressurised stream of gas is directed through the fourth expansion turbine, then through the heat exchanger in a counter-flow direction to the first portion of the pressurised stream of gas.

The cryogenic liquefaction device may further comprise a fifth expansion turbine, wherein the arrangement of conduits is arranged such that:

the third portion of the pressurised stream of gas is directed through the fifth expansion turbine after passing through the fourth expansion turbine and the heat exchanger.

The cryogenic liquefaction device may further comprise a second phase separator and a second expansion device, wherein the arrangement of conduits is arranged such that at least a portion of the second portion of the pressurised stream of gas is directed through the second expansion device and the second phase separator after having passed through the first expansion turbine.

The or each expansion device may comprise a Joule-Thomson valve, another pressure reducing valve, an expansion turbine or another work extracting device.

The cryogenic liquefaction device may further comprise a first compressor, wherein the arrangement of conduits is arranged such that at least a portion of the second portion of the pressurised stream of gas is directed through the first compressor before passing through the first expansion turbine.

The cryogenic liquefaction device may further comprise a second compressor, wherein the arrangement of conduits is arranged such that the first portion of the pressurised stream of gas is directed through the second compressor before passing through the heat exchanger.

The cryogenic liquefaction device may further comprise a cooler, wherein the arrangement of conduits is arranged such that the first portion of the pressurised stream of gas is directed through the cooler after passing through the second compressor and before passing through the heat exchanger.

The cryogenic liquefaction device may further comprise a feed stream compressor adapted to output the pressurized stream of gas, wherein the arrangement of conduits is arranged firstly such that a feed stream is directed to the input of the feed stream compressor; and secondly such that the output stream from the first phase separator joins the feed stream after passing through the heat exchanger.

The arrangement of conduits may be arranged such that the pressurized stream of gas output from the feed stream compressor is directed to a heat storage device before passing through the heat exchanger.

The arrangement of conduits may be arranged such that the pressurized stream of gas output from the heat storage device is directed to a heat rejection device before passing through the heat exchanger.

The first aspect of the present invention further provides a method for thermally balancing a liquefaction process with the use of cold recycle from an external thermal energy source comprising:
directing a first portion of a pressurised stream of gas through a heat exchanger, a first expansion device, and a first phase separator;
directing a second portion of a pressurised stream of gas through a first expansion turbine, then through the heat exchanger in a counter-flow direction to the first portion of the pressurised stream of gas, and then through a second expansion turbine; and directing a heat transfer fluid through a cold recovery circuit and the heat exchanger; wherein:
   the operating inlet pressures of the first and second expansion turbines are different from one another.

Any of the optional features recited above in connection with the cryogenic liquefaction device may also be incorporated into the method of the first aspect of the present invention.

A second aspect of the present invention addresses these needs by providing, in a first embodiment, a cryogenic liquefaction device comprising:
a heat exchanger; a first phase separator; a first expansion device; a first expansion turbine; a first compressor; a cold recovery circuit including a heat transfer fluid; and
an arrangement of conduits, arranged such that: a first portion of a pressurised stream of gas is directed through the heat exchanger, the first expansion device and the first phase separator; a
second portion of the pressurised stream of gas is directed through the first expansion turbine, then through the heat exchanger in a counterflow direction to the first portion of the pressurised stream of gas, and then through the first compressor, and the heat transfer fluid is directed through the heat exchanger.

The arrangement of conduits may be arranged such that the output stream of the first compressor joins the pressurised stream of gas.

The arrangement of conduits may be arranged such that the output stream of the first compressor is directed into the heat exchanger before it joins the pressurised stream of gas. Alternatively, the arrangement of conduits may be arranged such that the output stream of the first compressor joins the pressurised stream of gas before it is directed into the heat exchanger.

The first compressor may be either a single stage or a multistage compressor.

The second aspect of the present invention further provides a method for balancing a liquefaction process with the use of cold recycle from an external thermal energy source comprising:
directing a first portion of a pressurised stream of gas through a heat exchanger, a first expansion device, and a first phase separator; directing a second portion of a pressurised stream of gas through a first expansion turbine, then through the heat exchanger in a counter-flow direction to the first portion of the pressurised stream of gas, and then through a first compressor; and directing a heat transfer fluid through a cold recovery circuit and the heat exchanger.

Any of the optional features recited above in connection with the cryogenic liquefaction device may also be incorporated into the method of the second aspect of the present invention.

### BRIEF DESCRIPTION OF THE DRAWINGS

Embodiments of the present invention will now be described with reference to the figures in which:

FIG. 1 shows a profile of the relative change in total enthalpy which a process gas undergoes during the cooling process (Relative Change of Total Enthalpy vs Cooled Stream Temperature);

FIG. 2 shows profiles of the relative change in total enthalpy which the cooling streams must undergo during the cooling process for systems with and without the use of large quantities of cold recycle (Relative Change of Total Enthalpy vs Cooled Stream Temperature);

FIG. 3 shows profiles of the relative change in total enthalpy which the cooling streams must undergo during the cooling process for ‘ideal’, ‘state of art’ and ‘present invention’ systems with the use of large quantities of cold recycle (Relative Change of Total Enthalpy vs Cooled Stream Temperature);

FIG. 4 shows a typical state of the art air liquefaction plant arrangement using the Claude cycle;

FIG. 5 shows a schematic of a cryogenic energy storage system liquefaction process according to a first embodiment of the first aspect of the present invention;

FIG. 6 shows a second embodiment of the first aspect of the present invention;

FIG. 7 shows a third embodiment of the first aspect of the present invention;

FIG. 8 shows a fourth embodiment of the first aspect of the present invention;

FIG. 9 shows a fifth embodiment of the first aspect of the present invention;

FIG. 10 shows a sixth embodiment of the first aspect of the present invention;

FIG. 11 shows a seventh embodiment of the first aspect of the present invention;

FIG. 12 shows a variation of the second embodiment of the present invention;

FIG. 13 shows a variation of the seventh embodiment of the present invention;

FIG. 14 shows an eighth embodiment of the present invention;

FIG. 15 shows a variation of the first embodiment of the present invention;

FIG. 16 shows another variation of the first embodiment of the present invention;

FIG. 17 shows yet another variation of the first embodiment of the present invention; and

FIG. 18 shows a first embodiment of the second aspect of the present invention.

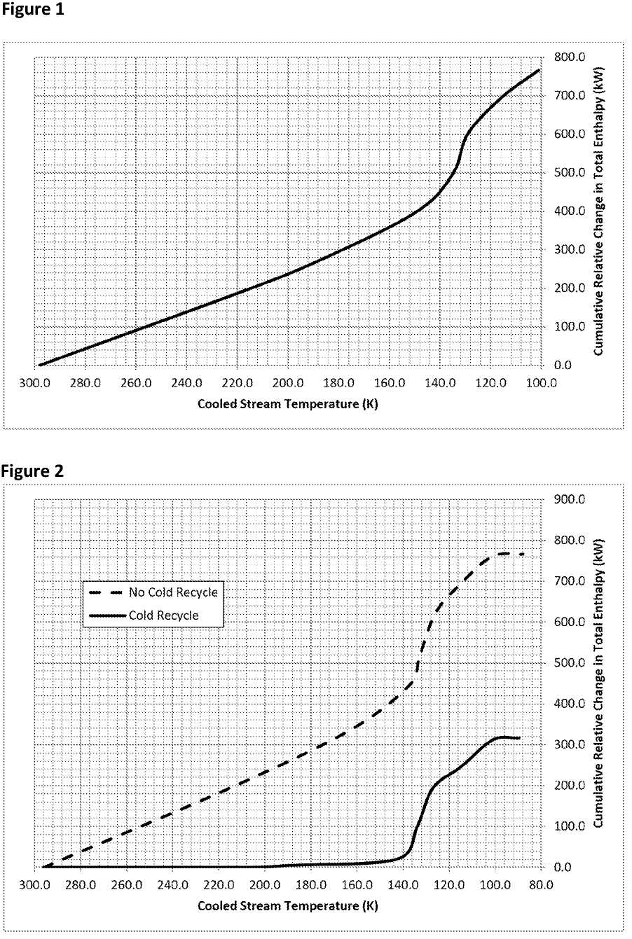

### DETAILED DESCRIPTION OF THE INVENTION

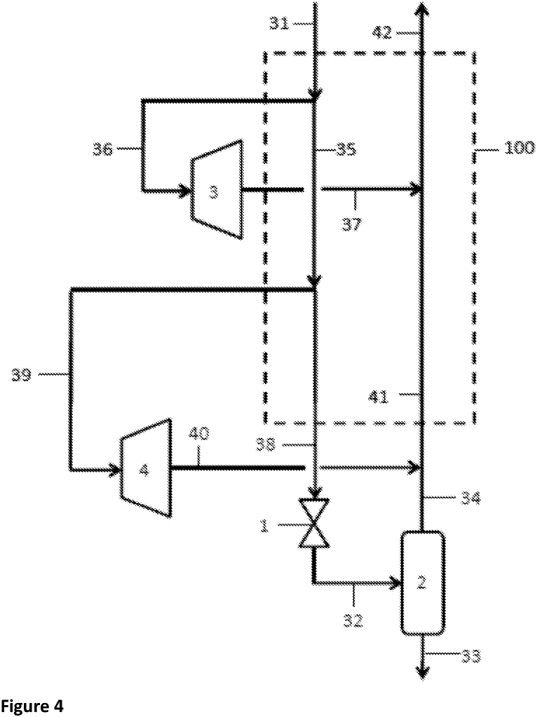

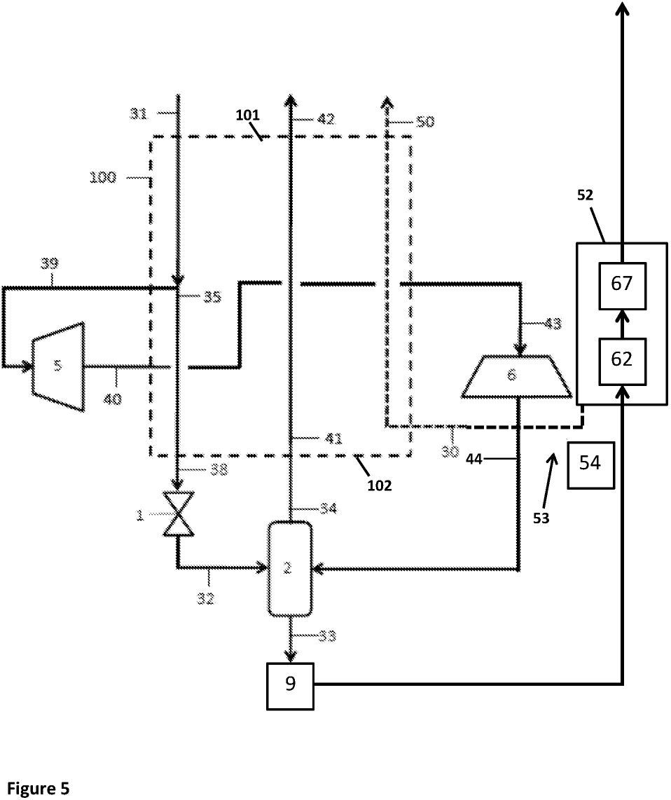

The first simplified embodiment of the present invention is shown in FIG. 5. The system in FIG. 5 is similar to that of the state of the art shown in FIG. 4 in that the main process stream 31 is cooled in a heat exchanger 100 via cold expanded air from turbines and expanded through an expansion device such as a Joule-Thomson Valve 1 to produce liquid, however the warm turbine 3 of FIG. 4 is replaced by a second cold turbine 6 aligned in series with the first cold turbine 5.

The heat exchanger has a first end 101 and a second end 102. The first end 101 is also known as the warm end 101 and the second end 102 is also known as the cold end 102. The temperature within the heat exchanger cools between the first warm end 101 and the second cool end 102 as can be seen in the table below.

In the first embodiment of the present invention shown in FIG. 5, the process gas (in the preferred embodiment air) is compressed to high pressure, of at least the critical pressure (which for air is 38 bar, more preferably >45 bar), and at ambient temperature (≈298K) enters the cryogenic liquefaction device at inlet 31, from where it is directed through the heat exchanger 100 from the first end 101 toward the second end 102 and cooled progressively by cold low pressure process gas, before returning through the full length of the heat exchanger 100 from the second end 102 to the first end 101 via passage 41, 42. Also passing through the heat exchanger 100 is a cold recovery stream 30, 50 of a cold recovery circuit 53 of the cryogenic liquefaction device. The cold recovery stream 30, 50 only passes through a portion of the heat exchanger 100. Preferably the cold recovery stream 30, 50 enters the heat exchanger 100 between the first end 101 and the second end 102 and exits at the first end 101. Preferably the cold recovery stream 30, 50 enters the heat exchanger 100 closer to the second end 102 than the first end 101 and further preferably passes through the heat exchanger for 90% of the length of the heat exchanger 100. The cold recovery circuit 53 comprises: a thermal energy storage device 52 for storing cold energy from evaporation of a working fluid in an evaporator 62; a means for circulating a heat transfer fluid 54 through the cold recovery circuit; and a second arrangement of conduits 30, 50 arranged to direct the heat transfer fluid through the thermal energy storage device 52 and the heat exchanger 100, as the cold recovery stream 30, 50. An exemplary cold recovery circuit 53 is described in detail in GB 1115336.8.

A proportion of the high pressure process gas input into the heat exchanger at 31, and now at a temperature of between 150-170K (in the preferred case 165K), is separated from the main flow 31, preferably within the heat exchanger 100, via passage 39, and is partially expanded to between 5 and 20 bar (more typically 10-14 bar), using expansion turbine 5, before passing through passage 40, 43 of the heat exchanger 100, where cold thermal energy is transferred to the high pressure gas in stream 35. Passage 39 exits the heat exchanger 100 between the first end 101 and the second end 102 and directs the gas stream to expansion turbine 5. Passage 40 directs the gas stream into the heat exchanger 100 closer to the cold end 102 of the heat exchanger 100 than passage 39 exits the heat exchanger 100. Passage 43 exits the heat exchanger 100 closer to the warm end 101 of the heat exchanger 100 than passage 40 enters the heat exchanger 100. The passages 40, 43 pass the separated gas through the heat exchanger in a counter-flow direction to the main flow 31, away from the second end 102 toward the first end 101. Preferably passage 43 exits the heat exchanger 100 closer to the first end 101 than passage 39 exits the heat exchanger 100.

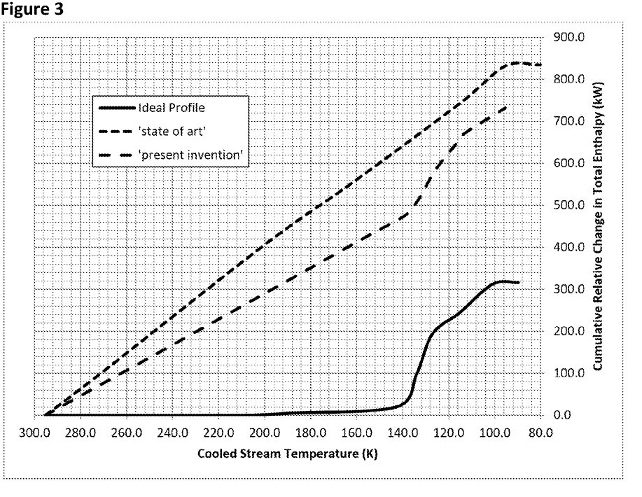

This feature of the present invention provides more effective cooling than the arrangement of FIG. 4 as a result of the higher pressure cooling stream 40, 43 around the entry point of the cold recovery stream 30, better matching the resultant cooling demand (as shown in FIG. 3) than conventional layouts, where the warm turbine 3 (of FIG. 4) provides cooling at higher temperatures which are not required where cold recycle is available. The cold recovery stream 30, 50 enters the heat exchanger 100 between the first end 101 and the second end 102, at a point closer to the second end 102 than the main process stream 31 separates to passage 39 and passage 35. Further preferably the cold recovery stream 30, 50 enters the heat exchanger 100 closer to the second end 102 than passage 40, from first expansion turbine 5, enters the heat exchanger 100. Preferably, the cold recovery stream 30, 50 at least passes through the same portion of the heat exchanger 100 that the passages 40, 43 pass through in a counter-flow direction to passage 35. Further preferably the cold recovery stream 30, 50 exits the heat exchanger 100 at the first end 101.

The partially expanded gas stream in passage 40, 43 is heated to a temperature between 120-140K (in the preferred case 125K), as a result of the thermal transfer in passage 40, 43 through heat exchanger 100, and is further expanded through turbine 6, to between ambient and 6 bar where it travels through passage 44 and enters the phase separator vessel 2. The gas fractions of streams 32 and 44 are combined to form output stream 34, which travels through passage 41, 42 through heat exchanger 100 which provides additional cooling to the high pressure process stream 35. An additional advantage of the present invention is that the typical composition of the cold process stream in stream 44 is a mixture of liquid and gaseous air. The liquid fraction from the final expansion is collected within the phase separator 2 and output via passage 33.

The numbered points in FIG. 5 indicate positions in the system at which typical absolute pressures, temperatures and mass flows are as follows:

| Point | Temperature (K) | Pressure (bar) | Mass Flow (kg/hr) |
|---|---|---|---|
| 31 | 298 | 45 | 16651 |
| 35 | 165.5 | 45 | 7160 |
| 38 | 101 | 45 | 7160 |
| 32 | 91.23 | 4 | 7160 |
| 33 | 91.23 | 4 | 6249 |
| 34 | 91.23 | 4 | 911 |
| 39 | 165.5 | 45 | 9491 |
| 40 | 113 | 11.23 | 9491 |
| 43 | 125.5 | 11.23 | 9491 |
| 44 | 95.91 | 4 | 9491 |
| 41 | 95.49 | 4 | 10402 |
| 42 | 295.3 | 4 | 10402 |
| 30 | 115 | 1.2 | 8280 |
| 50 | 295.3 | 1.2 | 8280 |

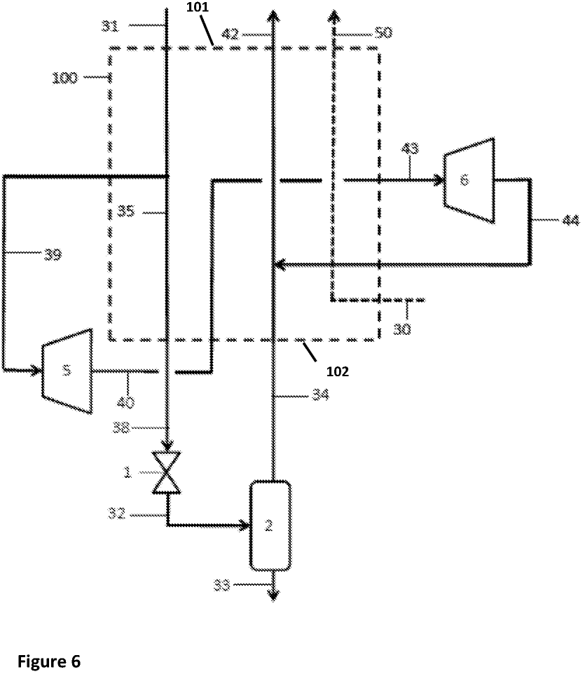

A second embodiment of the current invention is shown in FIG. 6 (where like reference numerals refer to the same components as in FIG. 5), wherein the proportion of air separated from the main stream 31 via passage 39 is carried out later in the process and therefore at a lower temperature (between 130-170K). As a result the subsequent temperature of the cold gas after partial expansion in turbine 5, is sufficient to provide a high pressure cooling stream for the bottom end of the process stream 35 via passage 40, 43, after which it is expanded again through the second turbine 6 to provide additional focussed cooling in stream 34.

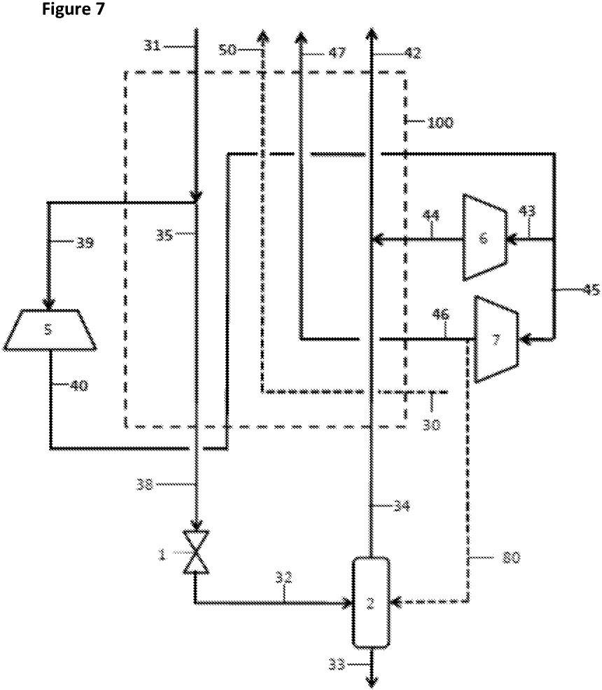

A third embodiment of the present invention is shown in FIG. 7 (where like reference numerals refer to the same components as in FIG. 5) wherein a third expansion turbine 7 is provided in parallel with the second turbine 6 which remains in series with turbine 5. Similar to the second embodiment shown in FIG. 6, a portion 39 of the cold high pressure stream 31 is partially expanded by turbine 5 to provide a high pressure cooling stream 40 at the lower end of the heat exchanger only, before it is split again into two streams 43, 45 and expanded through the two further turbines 6 and 7 in parallel. The outlet from turbine 7 is introduced typically into the phase separator 2 via passage 80. In some embodiments where the cold recycle temperatures are low the outlet from turbine 7 may be introduced higher up the heat exchanger 100 via passage 46.

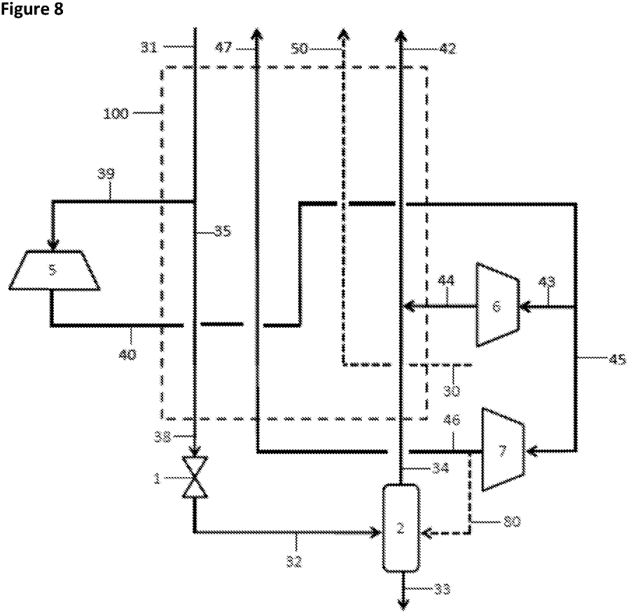

FIG. 8 (where like reference numerals refer to the same components as in FIG. 7) details a fourth embodiment of the present invention wherein, similar to the system shown in FIG. 7, a third expansion turbine 7 is added and placed in parallel to the second expansion turbine 6 which remains in series with the first expansion turbine 5. The expansion ratios of the second 6 and third 7 turbines are different from each other, the second expanding from around 8 bar to 4.5 bar, and the third expanding from around 8 bar to near ambient. The inventors have realised that by layering multiple cooling streams in parallel as in FIG. 8, the cooling profile demand, identified in FIG. 3, can be more closely matched. In some embodiments, where the outlet pressure of turbine 7 is substantially equal to the separator pressure 2, the outlet of turbine 7 is introduced to the phase separator 2 via passage 80 where liquid formed in the outlet of turbine 7 is collected.

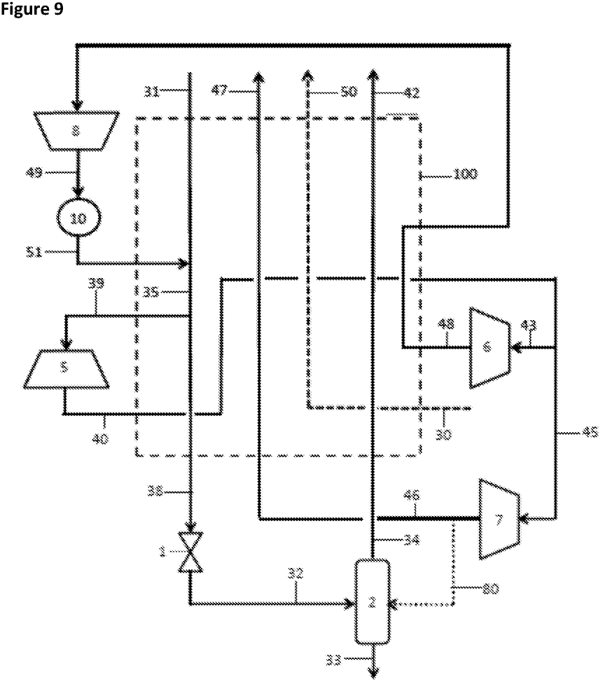

A further embodiment is shown in FIG. 9 (where like reference numerals refer to the same components as in FIG. 8). This embodiment is the same as that of FIG. 8 except that the exiting gases travelling through stream 48 from the second expansion turbine 6 are removed from the process heat exchanger 100 before reaching the top. The cold gases in stream 48 are further compressed, by compressor 8, and the resultant stream 49 is cooled by a closed cycle refrigeration circuit 10 before exiting the circuit 10 as stream 51 and mixing with the high pressure process stream 31. In certain embodiments there is the potential for a proportion of liquid to be formed in stream 46 from the cold gas on exiting the third turbine 7, whereby the stream would be directed via passage 80 to enter the phase separator 2, instead of being directed straight through the heat exchanger 100 via passageway 46, 47.

In a further embodiment (not shown but otherwise the same as FIG. 9), the outlet of turbine 7 may be expanded to near ambient so that this process stream can be used to drive a low pressure high grade cold store, such as that detailed in GB1115336.8.

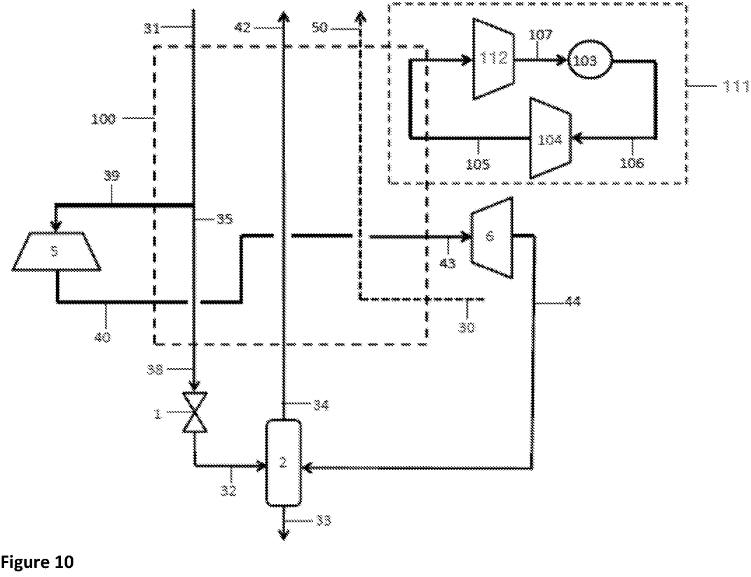

The embodiment shown in FIG. 10 (where like reference numerals refer to the same components as in FIG. 5) is the same as that of FIG. 5 except for the addition of a closed cycle refrigeration circuit 111 to provide a local potentially high pressure cooling stream 60 to better match the cooling demand. The closed cycle refrigeration circuit 111 includes compressor 112, cooler 103 and expansion turbine 104.

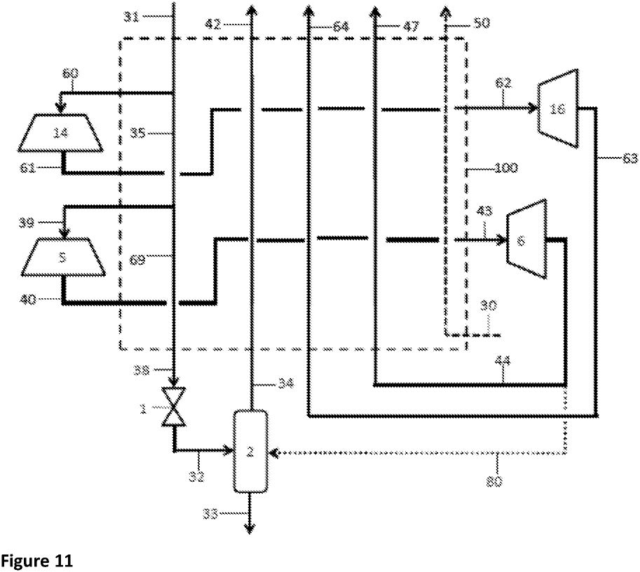

FIG. 11 shows a further embodiment of the present invention (where like reference numerals refer to the same components as in FIG. 5) wherein a warm turbine 14 and cold turbine 5 partially expand portions 60, 39 of the cold high pressure stream 31. Streams 60 and 39 are at different temperatures and are expanded to different pressures by turbines 14 and 5 to provide streams 61 and 40, respectively. Gas in streams 61 and 40 provides focussed cooling to the high pressure stream at points 35 and 69, before separately being expanded to between 0 and 6 bar, using further turbines 16 and 6 to provide streams 63 and 44 which are directed through heat exchanger 100. Optionally, the output of turbine 6 can be returned to the separator 2 as in FIG. 5.

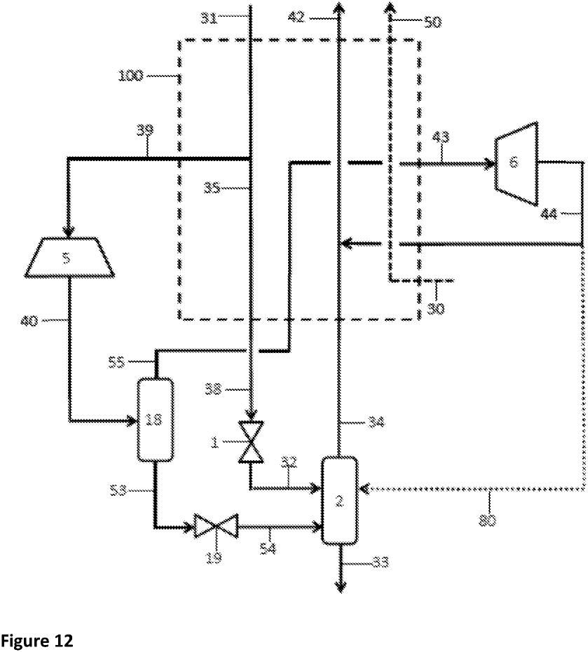

A variation to the second embodiment is shown in FIG. 12 (where like reference numerals refer to the same components as in FIG. 6) wherein the addition of a second phase separator 18 and pressure reducing valve 19 enable the removal of additional liquid produced in stream

40. In some embodiments the outlet pressure of turbine 6 is equal to the separator pressure 2 and the outlet of turbine 6 is introduced to the phase separator via passage 80 where liquid formed in the outlet to turbine 7 is collected.

A further component (not shown), which can be included in any of the previous embodiments is a closed loop refrigeration cycle (similar to cycle 111 shown in FIG. 10), that utilises a different working fluid to provide additional cooling at a specific section of the system where the cooling requirements are particularly high, in particular between 140 and 120K. The different working fluid may comprise a refrigerant such as methane.

A further arrangement, which can be applied to any of the previous embodiments where the high pressure stream is divided into two streams of different pressure, includes providing the first stream (that is cooled and then transferred to the expansion device) at a pressure above the critical pressure to maximise liquid production. The second high pressure stream is at a different pressure (typically above the first stream pressure) and is cooled and transferred to the two or more expansion turbines to provide additional cooling to the first stream as described in the previous embodiments.

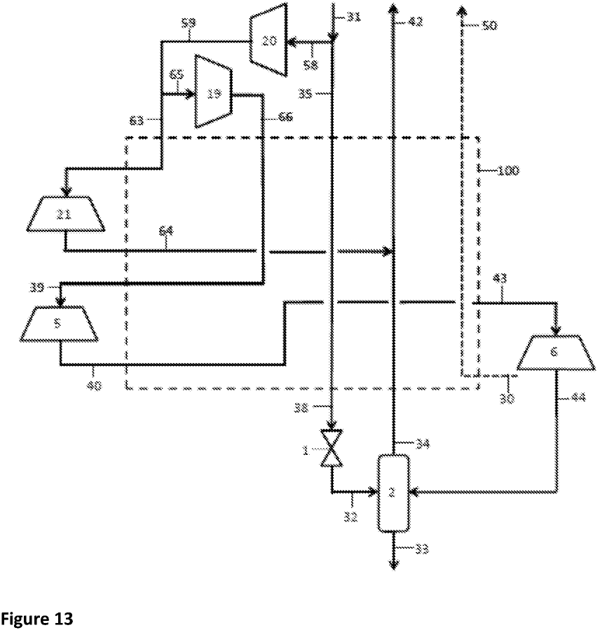

In a further embodiment as shown in FIG. 13 (where like reference numerals refer to the same components as in FIG. 5) the second stream 58 is compressed by compressor 20 to stream 59 and is then divided into a further two or more streams 63, 65. Stream 65 is compressed by compressor 19 and then directed, via a first stream 66, through two turbines 5, 6 in series. Stream 63 is expanded through a third turbine 21. The outlet streams 40, 44, 64 of the first, second and third turbines 5, 6, 21 provide additional cooling for the first process stream 35 prior to expansion in an expansion device such as a Joule-Thomson valve 1.

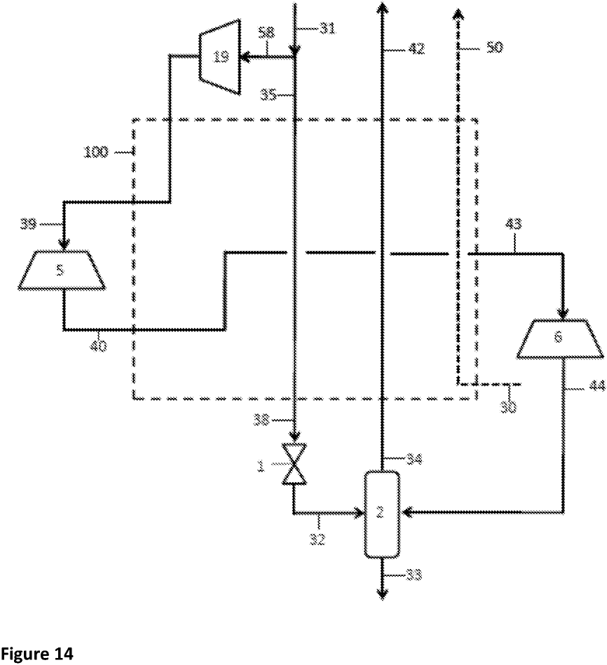

In a further embodiment, as shown in FIG. 14 (where like reference numerals refer to the same components as in FIG. 5) applied to the first embodiment, the cooled gas stream 31 is fed directly from a compressor commonly referred to as a Recycle Air Compressor (RAC) and a stream 58 is split from the cooled gas stream 31 and subsequently boosted to a higher pressure by compressor 19 before being directed through expansion turbines 5 and 6 and heat exchanger 100. This additional booster component can be incorporated into any of the previous embodiments.

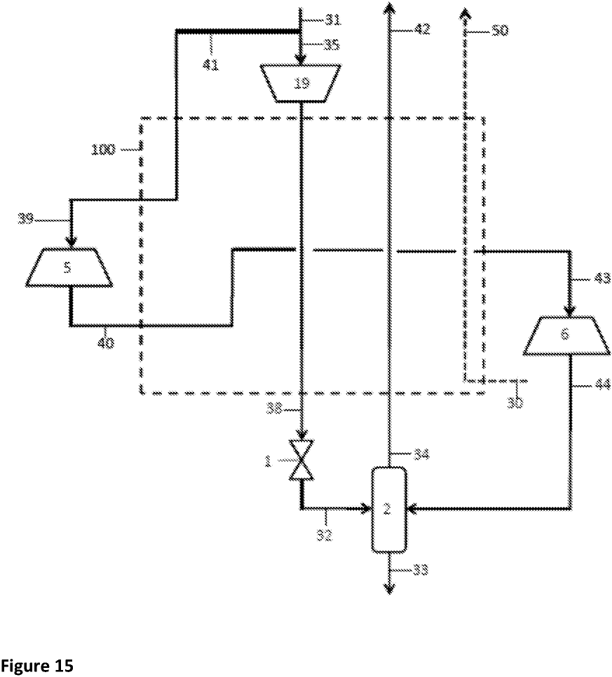

FIG. 15 (where like reference numerals refer to the same components as in FIG. 14) shows a variation of the embodiment of FIG. 14 whereby stream 31 is fed directly from the RAC. Stream 31 is split into two streams 41 and 35; stream 41 is directed through heat exchanger 100, where it is cooled before being directed through expansion turbines 5 and 6 and again heat exchanger 100, while stream 35 is boosted to a higher pressure by booster 19 before being directed through heat exchanger 100 and an expansion device such as a Joule-Thomson valve 1.

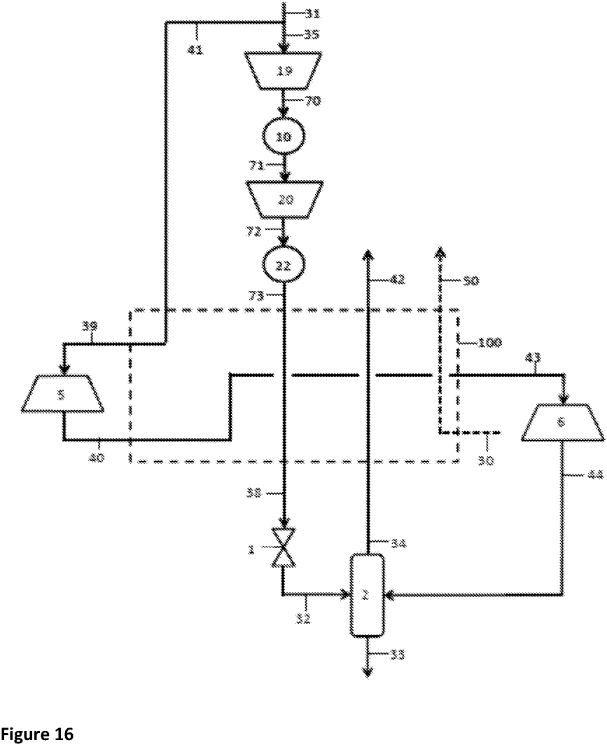

FIG. 16 (where like reference numerals refer to the same components as in FIG. 15), shows a variation where stream 31 is again fed directly from the RAC and compressed to a pressure lower than the critical pressure (<38 bar). Stream 41 splits from the main cooled stream 31 prior to the remainder of the main cooled stream 35 being boosted and subsequently cooled by boosters 19 and 20, and coolers 10 and 22. The sub critical pressure stream 41 is cooled via heat exchanger 100 before being partially expanded, to between 5 and 20 bar, but more typically 10-14 bar, through expansion turbine 5 before passing through passage 40, 43, of the heat exchanger 100, where cold thermal energy is transferred to the high pressure gas in stream in passage 73, 38, and being further expanded by expansion turbine 6. The additional components arranged in stream 35 can also be incorporated in any of the previous embodiments.

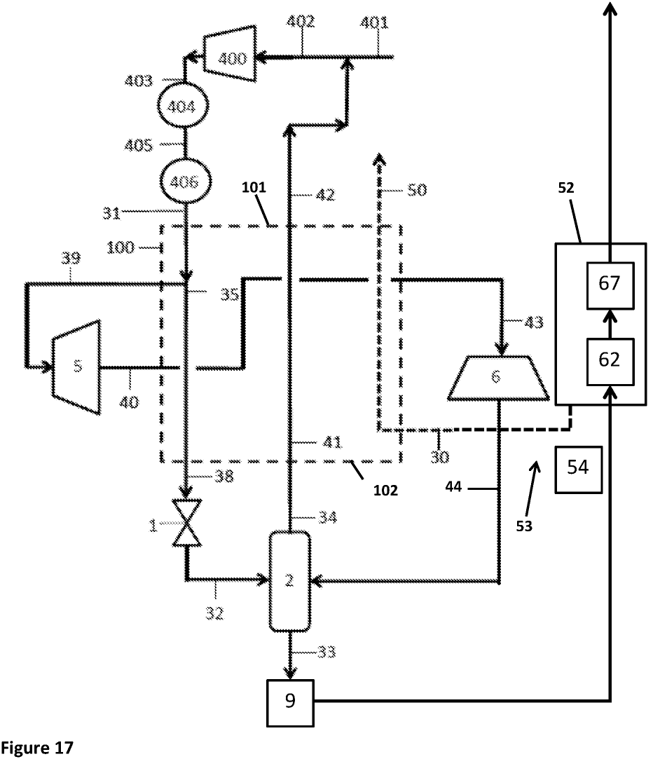

In the final embodiment, as shown in FIG. 17 (where like reference numerals refer to the same components as in FIG. 15 and FIG. 5) shows a variation of FIG. 5 and includes the components of FIG. 5 in the same position where output stream 34 of the first phase separator 2 enters the heat exchanger 100 at the second end 102 passing gas through the heat exchanger 100 in a counter-flow direction to the main flow 31 to passage 42 which exits the heat exchanger 100 at the first end 101. The output stream of the phase separator 2 then becomes low pressure return vapour 42, having passed through the heat exchanger 100, and merges with a feed stream 401 to form stream 402. The pressure of stream 402 can be between 3 barA and 15 barA, more typically 8 barA. Stream 402 is directed to a single stage compressor 400, which boosts the stream 402 to a higher pressure. The output stream 403 of the single stage compressor 400 therefore has a higher pressure than stream 402. The higher pressure is at least the critical pressure (which for air is 38 bar, more preferably >45 bar). The temperature of stream 403 can be between 100degC and 400degC, more typically 270degC. Stream 403 is directed to a heat storage device 404 which removes at least some of the heat energy in the stream 403. The temperature of the output stream 405 of the heat storage device 404 can be between 20degC and 100degC, more typically 60degC. If the temperature of stream 405 is above ambient temperature the heat rejection device 406 may be used to cool the temperature of the stream. When this liquefaction cycle is used as part of a cryogenic energy storage (CES) plant the liquified gas is stored as a cryogenic fluid in a storage tank 9 and subsequently released and evaporated in an evaporator 62 before being used to drive a power recovery expansion turbine 67 for producing electricity during the discharge or power recovery phase. When used in a CES system, in order to achieve greater efficiencies, the liquefaction process utilises cold energy captured in the evaporation of the working fluid during the power recovery phase. This is stored by means of an integrated thermal energy storage device 52, and then used during the charging phase to provide additional cooling to the main process stream in the liquefaction process using a cold recovery circuit 53. The effective use of the cold recovery stream 30, 50 is a prerequisite to achieving an efficient cryogenic energy storage system. It is highly preferable that the heat of compression captured by the heat storage device 404 is used in the power recovery cycle to boost the temperature of the working fluid at the inlet of the power recovery expansion turbines 67.

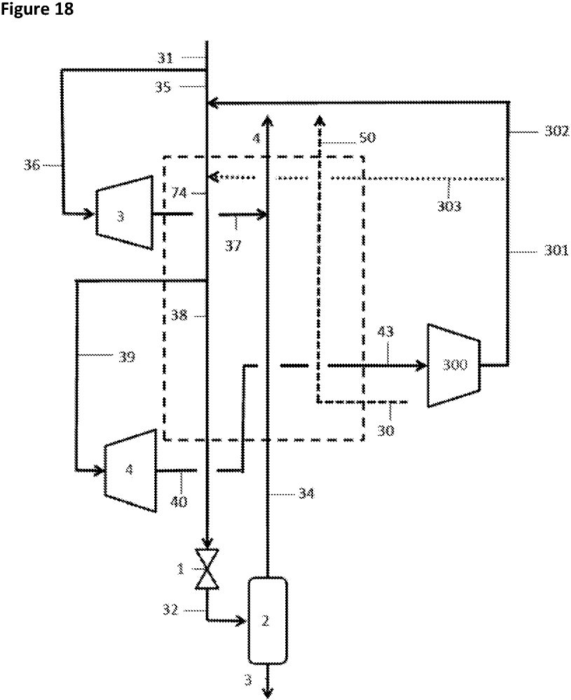

FIG. 18 (where like reference numerals refer to the same components as in FIG. 4) shows an embodiment of the invention which is a further development of the air liquefaction plant arrangement of FIG. 4. Here, the cold vapour stream 40, which is output from the expansion turbine 4, is directed to the heat exchanger 100 rather than merging with returning stream 34 to form stream 41 as shown in FIG. 4. The cold vapour stream 40 thus gains heat as it passes through the heat exchanger 100 and exits the heat exchanger as stream 43. The temperature of stream 43 can be between 0degC and 180degC, more typically -117degC. Stream 43 is directed to a compressor 300, which boosts the stream 43 to a higher pressure. The compressor 300 can be a multistage compressor or a single stage compressor. The output stream 301 of the compressor 300 is directed back to heat exchanger 100 in one of two arrangements. If the temperature of stream 301 is near ambient temperature then it can be directed to merge with stream 35 outside the heat exchanger 100. This is shown by stream 302. Alternatively, if the temperature of stream 301 is below ambient temperature then it can be directed to merge with the stream 35 insider the heat exchanger to form stream 74. This is shown by stream 303.

It will of course be understood that the present invention has been described by way of example, and that modifications of detail can be made within the scope of the invention as defined by the following claims.

Any system feature as described herein may also be provided as a method feature, and vice versa. As used herein, means plus function features may be expressed alternatively in terms of their corresponding structure.

Any feature in one aspect may be applied to other aspects, in any appropriate combination. In particular, method aspects may be applied to system aspects, and vice versa. Furthermore, any, some and/or all features in one aspect can be applied to any, some and/or all features in any other aspect, in any appropriate combination.

It should also be appreciated that particular combinations of the various features described and defined in any aspects can be implemented and/or supplied and/or used independently.

1. A cryogenic energy storage system comprising:
a cryogenic liquefaction device for liquifying a working fluid of the cryogenic energy storage system;
a storage tank configured to store the working fluid from the liquefaction device;
a cold recovery circuit including a heat transfer fluid; and
a power recovery turbine configured to be driven by the working fluid from the storage tank to produce electricity;
the liquefaction device comprising:
a feed stream for supplying a gas for liquefaction;
a feed stream compressor adapted to output a pressurised stream of gas;
a heat storage device for capturing the heat of compression from the pressurised stream of gas from the feed stream compressor;
a heat exchanger;
a first phase separator;
a first expansion device;
a first expansion turbine;
a second expansion turbine; and
a first arrangement of conduits, wherein:
the operating inlet pressures of the first and second expansion turbines are different from one another; and
the first arrangement of conduits is arranged such that:
the feed stream is connected to the input of the feed stream compressor;
the output of the feed stream compressor is connected to the heat storage device before the pressurised stream of gas output from the feed stream compressor passes through the heat exchanger where it is divided within the heat exchanger into a first portion of the pressurised stream of gas and a second portion of the pressurised stream of gas;
the first portion of the pressurised stream of gas is directed through a remaining portion of the length of the heat exchanger, the first expansion device and the first phase separator;
a second portion of the pressurised stream of gas is directed through the first expansion turbine, then through the heat exchanger in a counterflow direction to the first portion of the pressurised stream of gas, and then through the second expansion turbine,
and the heat transfer fluid is directed through the heat exchanger;
the cold recovery circuit comprising:
the thermal energy storage device for storing cold energy;
a means for circulating the heat transfer fluid;
a second arrangement of conduits arranged to direct the first heat transfer fluid through the thermal energy storage device and through the heat exchanger;
wherein heat of compression captured by the heat storage device is used to boost the temperature of the working fluid at an inlet of the power recovery turbine.

2. The cryogenic energy storage system of claim 1, further comprising an evaporator configured to evaporate the working fluid from the storage tank, wherein the cold recovery circuit is configured to capture cold energy from the evaporation of the working fluid from the storage tank.

3. The cryogenic energy storage system of claim 1 wherein the cold recovery circuit comprises:
a thermal energy storage device;
a means for circulating the heat transfer fluid; and
an arrangement of conduits arranged to direct the heat transfer fluid through the thermal energy storage device and the heat exchanger.

4. The cryogenic energy storage system of claim 1, wherein the pressurised stream of gas consists of gaseous air or gaseous nitrogen.

5. The cryogenic energy storage system of claim 4, wherein the pressurised stream of gas is input into the cryogenic liquefaction device from the feed stream compressor at a pressure greater than or equal to the critical pressure.

6. The cryogenic energy storage system of claim 1, wherein the first portion of the pressurised stream of gas and the second portion of the pressurised stream of gas are at different pressures.

7. The cryogenic energy storage system of claim 1, wherein the first portion of the pressurised stream of gas and the second portion of the pressurised stream of gas are at the same pressure.

8. The cryogenic energy storage system of claim 1, wherein the first expansion device comprises a Joule-Thomson valve, another pressure reducing valve, an expansion turbine, or another work extracting device.

9. The cryogenic energy storage system of claim 1, and further comprising a second phase separator and a second expansion device, wherein the arrangement of conduits is arranged such that at least a portion of the second portion of the pressurised stream of gas is directed through the second expansion device and the second phase separator after having passed through the first expansion turbine.

10. The cryogenic energy storage system of claim 9, wherein the second expansion device comprises a Joule-Thomson valve, another pressure reducing valve, an expansion turbine or another work extracting device.

11. The cryogenic energy storage system of claim 1, wherein the output from the second expansion turbine is directed into the first phase separator.

12. The cryogenic energy storage system of claim 1, wherein the arrangement of conduits is arranged such that the pressurized stream of gas output from the heat storage device is directed to a heat rejection device before passing through the heat exchanger.

13. The cryogenic energy storage system of claim 1 wherein the heat storage device is located downstream of the feed stream compressor and upstream of the heat exchanger.

14. The cryogenic energy storage system of claim 1 wherein the heat exchanger has a first end and a second end, the first arrangement of conduits enters the heat exchanger from the thermal storage device at the first end and the second arrangement of conduits of the cold recovery circuit enters the heat exchanger toward the second end of the heat exchanger for providing additional cooling to the pressurised stream of gas.

15. The cryogenic energy storage system of claim 1 wherein the heat exchanger has a first end and a second end, the first arrangement of conduits enters the heat exchanger from the heat storage device at the first end and the second arrangement of conduits of the cold recovery circuit enters the heat exchanger closer to the second end than the second portion of the pressurised stream of gas is directed through the heat exchanger from the first expansion turbine.

16. The cryogenic energy storage system of claim 1 connectable to an electricity supply grid for receiving surplus electrical energy for storage by liquefaction.

17. A cryogenic liquefaction device comprising:
a feed stream for supplying a gas for liquefaction;
a feed stream compressor adapted to output a pressurised stream of gas;
a heat storage device for capturing the heat of compression from the pressurised stream of gas from the feed stream compressor;
a heat exchanger;
a first phase separator;
a first expansion device;
a first expansion turbine; and
a first arrangement of conduits, arranged such that:
the feed stream is connected to the input of the feed stream compressor;
the output of the feed stream compressor is connected to the heat storage device before passing through the heat exchanger;
the first arrangement of conduits separates in the heat exchanger to provide, a first portion of a pressurised stream of gas directed through the heat exchanger, the first expansion device and the first phase separator; and
a second portion of the pressurised stream of gas directed through the first expansion turbine, then through the heat exchanger in a counter-flow direction to the first portion of the pressurised stream of gas;
a cold recovery circuit including:
a heat transfer fluid;
a means for circulating heat transfer fluid;
a second arrangement of conduits arranged to direct the first heat transfer fluid through the thermal energy storage device and through the heat exchanger;
wherein the heat exchanger has a first end and a second end;
the first arrangement of conduits enters the heat exchanger from the thermal storage device at the first end;
the first portion of the pressurised stream of gas is directed from the first end to the second end;
the second portion of the pressurised stream of gas enters the heat exchanger from the expansion turbine between the first end and the second end and is directed toward the first end in said counter-flow direction.

18. A cryogenic liquefaction device of claim 17 wherein the second arrangement of conduits of the cold recovery circuit enters the heat exchanger a similar distance from the second end as the second portion of the pressurised stream of gas is directed through the heat exchanger from the first expansion turbine.

19. A method for balancing a liquefaction process with the use of cold recycle from an external thermal energy source comprising:
directing a pressurised stream of gas from a feed stream compressor through a heat storage device to a heat exchanger having a first end and a second end,
directing a first portion of said pressurised stream of gas to the first end and through the heat exchanger to a first expansion device, a first phase separator and to a storage tank configured to store the working fluid from the liquefaction device;
directing a second portion of the pressurised stream of gas through a portion of the heat exchanger, a first expansion turbine, then to re-enter the heat exchanger and pass through the heat exchanger in a counter-flow direction to the first portion of the pressurised stream of gas, and then through a second expansion turbine; and
directing a heat transfer fluid through a thermal energy storage device and through the heat exchanger through a cold recovery circuit and the heat exchanger; wherein: the operating inlet pressures of the first and second expansion turbines are different from one another.

20. A method for balancing a liquefaction process with the use of cold recycle from an external thermal energy source comprising:
directing a first portion of a pressurised stream of gas through a heat exchanger, a first expansion device, and a first phase separator;
directing a second portion of a pressurised stream of gas through a first expansion turbine, then through the heat exchanger in a counter-flow direction to the first portion of the pressurised stream of gas, and then through a first compressor; and
directing a heat transfer fluid through a cold recovery circuit and the heat exchanger.

21. The method of claim 20 wherein the heat transfer fluid is directed into the heat exchanger closer to the second end than the working fluid re-enters the heat exchanger from the first expansion turbine.

22. A method of storing energy including the method for balancing a liquefaction process of claim 19.
